(19) United States
(12) Patent Application Publication
(10) Pub. No.: US 2003/0093802 A1
(43) Pub. Date: May 15, 2003

(54) Pause/resume method of video reproduction in video system

(76) Inventors: Chang Sik Cho, Taejon (KR); Pyeong Soo Mah, Taejon (KR)

Correspondence Address: JACOBSON, PRICE, HOLMAN & STERN, PROFESSIONAL LIMITED LIABILITY COMPANY, 400 Seventh Street, N.W., Washington, DC, 20004, US

(21) Appl. No.: 10/015,689

(22) Filed: Dec. 17, 2001

(30) Foreign Application Priority Data
Sep. 20, 2001 (KR) 2001-58241

(51) Int. Cl. H04N 7/173

(52) U.S. Cl. 725/90; 725/87; 725/88

(57) ABSTRACT

The problem of the pause/resume method of patching based VOD system in a prior art, which a prescribed time interval is fixed and the service requested during the interval is processed, is solved by changing the channel group of transferred stream. When an operation of pause is performed, transmission of video data is temporarily paused, and when an operation of resume is performed, the nearest transferring channel group is found. However, the VOD system, which transfers simultaneously data via at most 2 channels, operations of pause/resume can not be provided. Therefore, to solve this problem, pause/resume method and its apparatus in the video system according to the present invention can provide the operations of the pause/resume of the VOD in multicasting environment, which data are simultaneously transferred via 2 channels. The present invention allows a user to interact for video data, thus increases utility of the system.

### BACKGROUND OF THE INVENTION

1. Field of the Invention

The present invention relates to a pause/resume method in video system, particularly a pause/resume method of transport streams under the situation that a client can receive simultaneously multimedia data through two channels of a network in a VOD (video-on-demand) system.

2. Background of the Invention

In recent years, there have been considerable progresses in the fields of semiconductor and communication system such as information super-highway, and users tend to use interactive communication instead of halfway communication. Such a need accelerates development of interactive television system by worldwide enterprises, which is evolution type than prevailing cable television system.

On the other hand, in the field of the interactive television system, a digital system may provides VOD services so that a viewer of television can receive immediately various information (for example, video, etc.) in desirable time. Establishment of such a VOD service requires information provider comprising mass storage server with the capability of storing and transmitting information, service provider such as television station, delivery system provider which delivers simultaneously information required by the service provider through a network to a number of viewers (users of television) in high speed, and user of the television which uses the service information delivered from the delivery system provider.

In general, VOD service may includes a movies-on-demand, a news-on-demand in which title of news or information of each of industries can be immediately received and service such as brief or headline news can be obtained, a provision service of image catalog in order for a user to purchase goods, a tele-shopping, a remote medical diagnosis service in which an end user can store and analyze x-ray image data and the result data can be transferred to another end user, a game service, a home banking service in which general banking services can be provided, tele-conferencing service, contract services in which a user can obtain desired information and trade can be established using the obtained information, and an Internet service for access to an Internet.

For example, the movies-on-demand service is that a user (or a client) can receive service such as VCR services, for example, selection, cancellation, start, pause, fast playback, rewind on a program from a VOD server of a provider through a network.

Also, in order to obtain a VOD service, a set-top unit of a user will receive various information such as a movie and an English-language education program from remote VOD server by user's manipulation, the VOD server will search a corresponding bit stream with video, audio and text data for the required program from a database in response to the request of the set-top unit, and then the searched bit stream will be transmitted to the client.

In this case, the program data provided from the VOD server to the client by the request of the client is in the form of compressed MPEG bit stream encoded in a certain bit rate. The encoded program data is decoded and displayed on a display in the client.

For a typical VOD server system, when a client requests a particular program, all of information on the program is retrieved from a database to transmit them to a client. Since transmission rate from a database, that is, maximum bit rate, which can be read from the database, depends on a capacity of a server system, mass storage of a server will make to establish more powerful VOD service.

However, even though a mass storage server system can be constructed, when requests from users are tremendously increased for service, for example, when amount of the requests exceeds maximum transmission rate of the server system, time delay (that is, transmission delay) occurs. At this point, if capacity of a server system is increased, transmission delay caused by the tremendous requests may be partially overcome, but it may not be an essential solution.

In addition, increasing capacity of a server system results in increase of cost in service, it is not desirable under consideration of commercializing VOD service,.

In order to solve such a problem, technique that uses a group based program services is employed to increase service efficiency in a server system with a restricted capacity. In this technique, a program service is not provided whenever a user requests a service for a particular program, but the service is waited during a predetermined time (for example, 30 seconds, 1 minute, etc.), the other users who request the identical program are gathered in one group within the waiting time, and then the program is transmitted to each user of the group. Now, batching technique utilizing such a multicasting will be briefly described with reference to FIG. 1.

FIG. 1 shows a block diagram of VOD system using multicasting, which consists of a plurality of clients 101, a network manager 102, a video server 103 and a database 104.

First, some of the plurality of clients 101 which request the identical service within a predetermined time, are set to a group. The network manager 102 creates a corresponding channel for each of groups which request an identical service, and requests a services (data) requested by each group to the video server 103.

The video server 103 retrieves data requested by each group (for example, video data, audio data, text data, etc.) from the database 104, and transmits the retrieved data to each client in each of the groups through each of the channels created by the network manager 102.

When a particular client sends a pause request in the course of performing operation of data service, the server system removes the client from the associated group and provides an individual program service to the client.

In this case, since a transmission line for VOD service must be needed to each of clients who send a pause request in the course of performing operation of data service. As the number of clients who send a pause request for a program increases, transmission efficiency of the server system decreases.

To solve such a problem, Korean Patent Application No. 10-1998-0019429(entitled “pause/resume method in VOD system) proposes a method of group-based program service to obtain a higher efficiency in a server system having a same capacity.

The above patent application will be briefly described.

This method includes setting a plurality of clients into a group, which request service for an identical program, and providing the requested program on the unit of group. When a particular client that is registered in the group sends a pause request for the program service, the client is removed from group and the service stops.

Then, time information about a point on the program associated with the service stop is stored.

After that, if the client who has requested the service stop in the course of performing operation of the service requests cancellation of the pause request for the program, the stored time information is retrieved, and a group which has a service execution time nearest to the retrieved time information is retrieved.

Then, the client is registered in a corresponding group associated with the retrieval, service which the client requests is resumed. Therefore, a user can be reliably provided function of pause and/or resume without damaging transmission rate or transfer line in the VOD system.

However, this pause/resume method in the prior VOD system still has a problem that service to each of clients must be postponed until next batch cycle, because the method employs batching technique which stores and maintains requests for a particular information from a client during a predetermined time (for example, 30 seconds, 1 minute, etc.) and processes actions for that requests simultaneously. That is, this method has a problem of time delay.

### SUMMARY OF THE INVENTION

Therefore, the present invention has been accomplished in view of the above-mentioned problems in the conventional processing apparatus. An object of the present invention is to provide an improved pause/resume method using patching technique, the patching technique capable of receiving simultaneously a multimedia data using two channels of a network. That is, a prior pause/resume in a batching based VOD system provides duration of a predetermined time to process requested services within the duration of the predetermined time substituted by changing a channel to one of the other channels, which is transmitting a stream to a client. However, a pause/resume method employed in the present invention needs to efficiently perform management of multicast channels and sessions to respective clients. Therefore, the present invention has an object to provide a method for minimizing use of multicasting channels in a video server and efficiently processing operations of pause/resume.

To solve the above problem, there is therefore provided, according to an aspect of the present invention, a pause method in a video system using a regular channel and a patched channel, comprising: determining if current session of an associated client is a single primary session in the regular channel, when receiving ID of the session and a reproduction position of a video from the client; in response to result of the determination, examining a stable pause enable time, if the session is the single primary session in the regular channel; in response to result of the examination, after pausing transmission of the video data to the client via the regular channel, obtaining an actual video transmission pause time and comparing it with the obtained stable pause enable time; and in response to result of the comparison, transferring the video data to the client via the regular channel, after releasing the pause, if the obtained stable pause enable time is longer than the actual transmission pause time. In this case, the transmission pause of the video information performs pausing as duration as the obtained stable pause enable time, and the stable pause enable time is the time which reproduction position of secondary session of the regular channel is subtracted from the transmission position of the regular channel.

Preferably, the method comprises the further steps of: determining if only the current regular channel exists in the associated client, when the current session is not the single primary session of the regular channel and when the actual transmission pause time is less than the stable pause enable time; and in response to result of the determination, receiving and storing only video informations as much as the current video information patching enable range from the regular channel, when only the current regular channel exists in the associated client.

Preferably, in the receiving and storing only video informations as much as the current video information patching enable range from the regular channel, video data as much as the patched length is stored in advance in the current session of the associated client, and the stable pause enable time, which represents additional storage enable video data in a pause enable state equals to the time that the patched length of the current session is subtracted from the patching enable range.

Preferably, when both of the regular channel and the patched channel exist in the step of determining if only the regular channel exists, the method further comprises: receiving video data as much as the patched length via the patched channel, and video data as much as the stable pause enable time via the regular channel.

There is further provided, according to another aspect of the present invention, a video data transfer resume method in a video system, comprising: determining, when a video reproduction is temporarily paused, if a video reproduction signal is received, after receiving informations including session ID, paused position and paused time; comparing the paused position with a predetermined stable pause enable time, when the video reproduction signal can be received within the predetermined stable pause enable time; in response to result of the comparison, determining if it is a single primary session in which associated client shares the regular channel, when the paused time falls within the stable pause enable time; in response to result of the determination, resuming transfer in the regular channel and adjusting patched lengths of sessions sharing the regular channel, when it is the single primary session; and transferring the patched length, the regular channel and patched channel value, which are adjusted, as pause enable resume value to the client.

Preferably, when it is not a single primary session in which the associated client shares the regular channel, the method further comprises: determining if only the regular channel exists in the associated client; and adding the pause enable time of the video reproduction to the patched length, when both of the regular channel and the patched channel exist.

Preferably, when the pause enable time not fall within the stable pause enable time, the method further comprises: performing jump operation for the pause enable position and creating a new regular channel and a new patched channel; and transferring information of waiting time to the client as video reproduction operation value via the new regular channel and the new patched channel.

There is further provided, according to another aspect of the present invention, a program storage device readable by a machine, tangibly embodying a program of instructions executable by the machine to perform method steps for providing for pause/resume of video reproduction in video system using a regular channel and a patched channel, the method steps comprising: determining if current session of an associated client is a single primary session in the regular channel, when receiving ID of the session and a reproduction position of a video from the client; in response to result of the determination, examining a stable pause enable time, if the session is the single primary session in the regular channel; in response to result of the examination, after pausing transmission of the video data to the client via the regular channel, obtaining an actual video transmission pause time and comparing it with the obtained stable pause enable time; and in response to result of the comparison, transferring the video data to the client via the regular channel, after releasing the pause, if the obtained stable pause enable time is longer than the actual transmission pause time.

There is further provided, according to another aspect of the present invention, a program storage device readable by a machine, tangibly embodying a program of instructions executable by the machine to perform method steps for providing for pause/resume of video reproduction in video system using a regular channel and a patched channel, the method steps comprising: determining, when a video reproduction is temporarily paused, if a video reproduction signal is received, after receiving informations including session ID, paused position and paused time; comparing the paused position with a predetermined stable pause enable time, when the video reproduction signal can be received within the predetermined stable pause enable time; in response to result of the comparison, determining if it is a single primary session in which associated client shares the regular channel, when the paused time falls within the stable pause enable time; in response to result of the determination, resuming transfer in the regular channel and adjusting patched lengths of sessions sharing the regular channel, when it is the single primary session; and transferring the patched length, the regular channel and patched channel value, which are adjusted, as pause enable resume value to the client.

### BRIEF DESCRIPTION OF THE DRAWINGS

The above and other features of the present invention and the manner of attaining them, will become apparent, and the invention itself will be best understood, by reference to the following description and the accompanying drawings, wherein:

FIG. 1 is a block diagram of multicast VOD system according to the prior art;

FIG. 2 is a schematic timing chart for explaining a patching technique of a general VOD system;

FIG. 3 is a schematic diagram for explaining a construction of a VOD system according to the present invention;

FIG. 4 shows an illustration for explaining relationship between a video reproduction position of a client and a transmission position on channels in a video system according to the present invention;

FIG. 5 shows an illustration for explaining concept of a pause/resume method in the video system according to the present invention, for each of types;

FIG. 6 illustrates a flow chart for explaining operations of pausing reproduction of a video in the video system according to the present invention; and

FIG. 7 illustrates a flow chart for explaining operations of resuming and reproduction of a video in the video system according to the present invention.

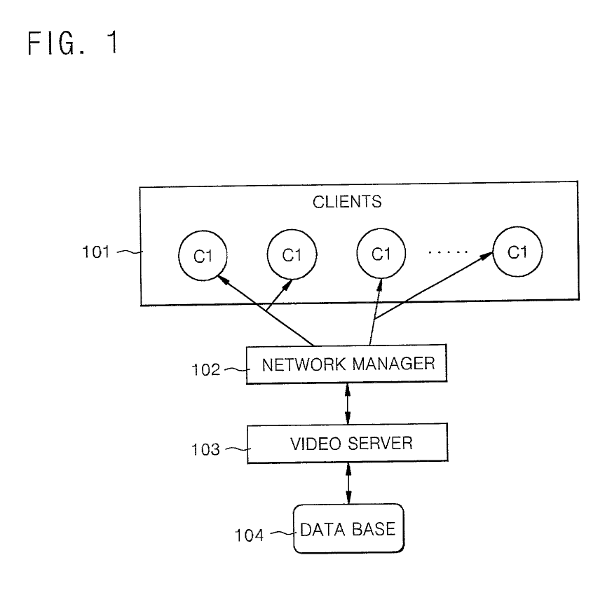

### DETAILED DESCRIPTION OF THE INVENTION

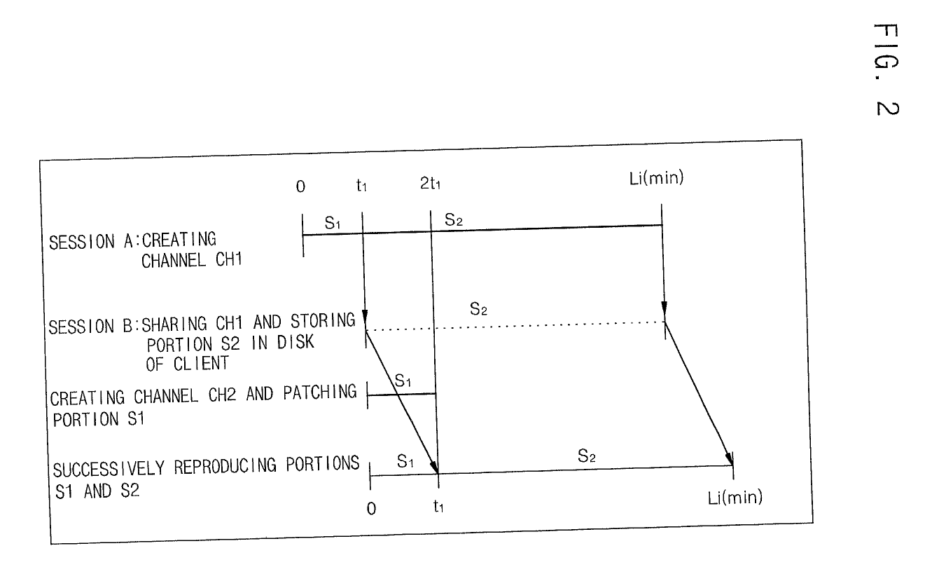

Prior to the description of a pause/resume method according to the present invention, patching technique to be employed in the present invention will now be briefly shown with reference to FIG. 2.

FIG. 2 is a schematic timing chart for explaining a patching technique of a general VOD system.

As described above, patching is a method for sharing current portion of a multicasting stream that is transmitted, temporarily storing it in a disk of a client, and receiving and reproducing previous portion of the stream that could not be shared, by creating a new channel. In the patching technique, reproduction of the current portion of the stream stored in the disk is performed, after reproduction of the previous portion of the stream has been completed.

Procedure of operations on the patching will now be described with reference to FIG. 2.

FIG. 2 illustrates an event that clients A and B successively request a service for an identical video having a size of Li(min) at intervals of time, in which a multicasting channel Ch1 is created for the client A.

With the client A reproducing the video at a point t1, if the client B requests a session as shown in FIG. 2, a portion S2 of the channel Ch1 can be shared to both of the client A and B and stored in a disk of the client B. For the portion S1 in the channel Ch1 that cannot be shared to the client B, a new channel Ch2 is created and the portion S1 is patched.

In procedure of reproduction in the client B, reproduction of the portion S1 patched from the channel Ch2 is performed and completed, then the portion S2 shared from the channel Ch1 and stored in the disk of the client B is reproduced. As a result, the disk of the client B always stores and maintains data by an amount of the portion S1 corresponding to a time interval t1.

Here, the channel Ch1 is designated as a regular multicast channel or a regular channel which is represented as MCr, and the channel Ch2 is designated as a patched multicast channel or a patched channel which is represented as MCp.

A stream transmitted through the regular channel is designated as a regular stream, and a stream transmitted through the patched channel is designated as a patched stream.

A patched interval designates distance that performs patching between two channels. A patched length designates duration of time corresponding to the patched interval. In FIG. 2, the patched interval of the client B is S1, and the patched length is t1.

The patching technique has advantages that bandwidth of a network can be reduced as much as an amount of sharable multicast stream and an initial waiting time of a client can be minimized. Also, the method has another advantage that for a less favorite video, bandwidth of a server in a network can be reduced.

Now, a preferred embodiment of method and apparatus for pause/resume according to present invention using the above patching method will be described with reference to the accompanying drawings.

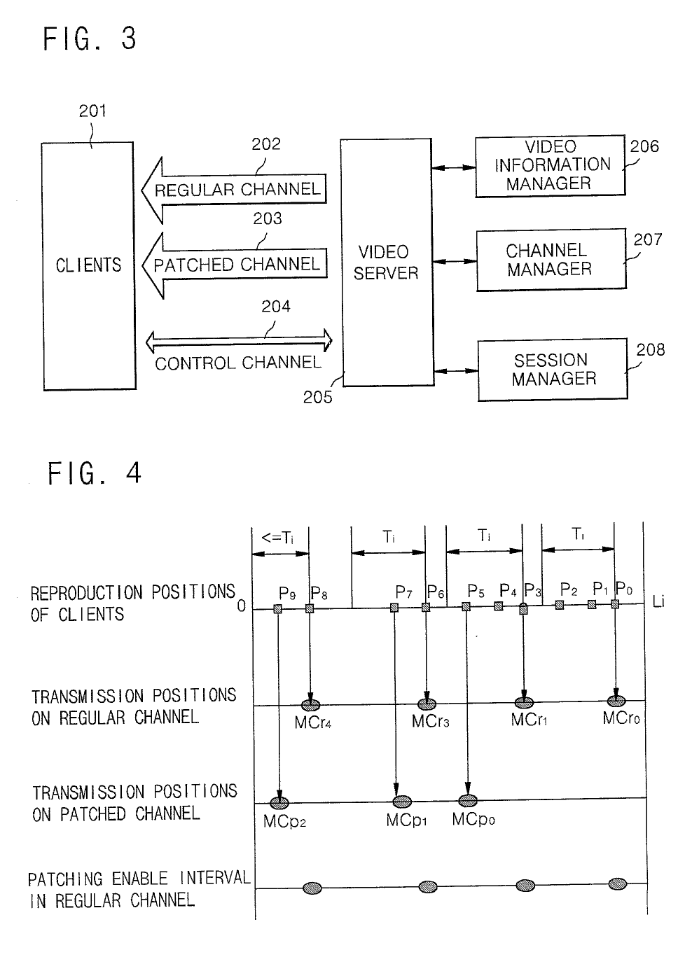

FIG. 3 is a schematic diagram for explaining a construction of a VOD system according to the present invention, in which the VOD system comprises a plurality of clients 201 and a video server 205, communication channels located between the clients 201 and the video server 205 and including a control channel 204, a regular channel 202 and a patched channel 203. The control channel 204 is used to deliver control messages between the video server 205 and the clients 201, and the regular channel 202 and the patched channel 203 is used to deliver actual data of videos.

In addition, the video server 205 can include a video information manager 206 that performs management for video information provided by the VOD system, a channel manager 207 which performs management for channels created by the video server 205 and a session manager 208 which performs management for session information of the channels.

Bandwidth of a network, which meets a playback rate for data of videos, calls a logical channel. The logical channel has a bandwidth corresponding to the sum of bandwidths required to deliver data of videos and control messages.

Now, assuming that the video server 205 has C logical channels and provides services for N videos, and the client 201 has storage space which can stores size B(min) of data of a video, FIG. 3 will be described.

A Table 1 below shows video information that is required for the video information manager 206 to manage data of the N videos.

TABLE 1

| VID | ID of video |
|---|---|
| Ai | Arrival rate of video i (request/min) |
| Ci | Number of channels assigned to video |
| Li | Length of video i (min) |
| Ti | Patching enable range of video i (min) |

The number of channels Ci assigned to a video i is calculated as a ratio of total arrival rate for the whole videos to the arrival rate λi of the video i. That is, the number of channels Ci is given by the following equation 1:

$${C}_{i} = \frac{{λ}_{i}}{\sum {λ}_{k}} \qquad ( 1 )$$

In patching, clients can simultaneously receive an identical stream through utmost 2 channels. A client can share the identical video, when at least one regular channel exists for it. However, with the passage of time, sharable regular streams can be reduced and/or length of to-be-patched streams can be increased, so continuous assignment of patched channels may be inefficient from a point of view in the use of channel in a network.

Therefore, even when patching is possible, it is desirable that by assigning a new regular channel, subsequent clients can share more regular streams. Share of existing channels can reduce total amount of the use of channels rather than creates new regular channels. Point of time, which an amount of the use of the whole channels can be reduced, is designates as an optimal patching enable time.

Patching enable range Ti, in which use of bandwidth of a network can be minimized for a particular video i, represents as a function having an optimized value by an arrival rate λi of the video and a size Li of the video. Ti decreases as λi increases, and increases as Li increases.

In addition, the patching enable time Ti also represents a maximum size of data to be stored in a disk of a client. Since a client can not patch data in excess of storage space of its disk, when capacity of the disk is less than Ti, value of Ti equals to size B(min) of the disk. That is, patching enable time Ti of a regular channel for a video is given by the following equation 2, and bandwidth of a network required to a video server is given by the following equation 3.

$$\begin{matrix}\{ \begin{matrix}{T}_{i} = \frac{\sqrt{2 {L}_{i} * {λ}_{i}} - 1}{{λ}_{i}} & \text{if} {T}_{i} < B \\ {T}_{i} = B & \text{otherwise}\end{matrix} & ( 2 ) \\ \sqrt{2 {L}_{i} * {λ}_{i}} - 1 & ( 3 )\end{matrix}$$

A Table 2 below shows information that is managed by the channel manager 207 of the video server 205 shown in FIG. 3.

TABLE 2

| | |
|---|---|
| MCID | ID of multicast channel |
| Mcvid | ID of video which is in service through multicast channel |
| Mctype | Transmit type including values of regular channel R and patched channel P |
| Mcstate | Transmit state including values of transmission S and pause P |
| Mcdelay | Paused time of multicast transmission (min) |
| MCstart | Absolute time which multicasting starts |
| MCbegin | Relative position (min) when transmit begins in video I, 0 ≦ MCbegin <Li |
| MCend | Relative position (min) when transmit ends in video I, 0 < MCend ≦ Li |
| | MCend = Li in the case of regular channel |
| MCps | Primary sessions |
| MCss | Secondary sessions |
| MCsn | Number of sessions belonging to channels |

To indicate a position on a video in a channel, position-time value is used. The position-time value represents a distance between a particular point and a start point on the video in time base.

A current transmission position on a channel or a current reproduction position in a client device is represented in the position-time value. In connection with a transmission on a channel, as shown in the above Table 2, MCbegin and MCend are values represented by indicating a transmission beginning position and a transmission end position of the video i in time value (min). For example, when MCbegin equals to 5 and MCend equals to 15, a position corresponding to 15 minutes of the video i is delivered to a position corresponding to 5 minutes of the video i.

Transmission through multicasts channel can be interrupted by an VCR operation. MCdelay is the whole time that the transmission has been interrupted. Then, if a current time is Tcurr and a beginning time on a multicast channel is MCstart, a current transmission position in the channel is given by the following equation 4.

T_{curr}−MCₛₜₐᵣₜ−MC_{delay}+MC_{begin} (4)

A Table 3 below shows session information that is managed by the session manager 208 shown in FIG. 3.

TABLE 3

| | |
|---|---|
| SID | ID of session |
| MCr | ID of regular stream channel |
| MCp | ID of patched stream channel |
| Plength | Patched length of session |
| B | Buffer size of client |

Pause/resume method of a video system according to the present invention, which comprises above constructions, will now be described.

FIG. 4 shows an illustration for explaining relationships between a video reproduction position of a client and a transmission position on a channel in the video system according to the present invention. FIG. 4 also represents relationships between channels and sessions, especially relationship among a reproduction position in a client which the video I is reproduced, a transmission position on a regular channel and a transmission position on a patched channel.

As illustrated in FIG. 4, the reproduction position and the transmission positions are represented in time values for particular positions in the video. In FIG. 4, clients are reproducing 10 different points p0 through p9, and the video is delivered through 7 multicast channels (including 4 regular channels and 3 patched channels).

In FIG. 4, a number of clients may exist for an identical reproduction position, and in this case, many of the clients may share a regular channel or a patched channel at an specified point.

When every available channels provided by a video server are in use, requests for creation of new channels by clients are collectively shared at a point of time that the channels can be used. Therefore, if every channel is in use, a waiting time is required until a new channel can be created to begin a service. When every channel is not in use, a reproduction position will connected to session of a client. In this case, waiting time for a service does not exist.

For a regular channel, interval between a transmission position on a regular channel and a patching enable time is designated as a patching enable interval. In addition, set of clients, which share a stream on a regular channel, is designated as a patched group, that is, set of clients that are reproducing the patching enable interval on a regular channel. In FIG. 4, the clients reproducing positions p0, p1 and p2 are included in a patched group sharing position MCr0 on a regular channel. Each of the clients has its patched length that represents size of data to be stored in a disk of each client.

Each session of clients belonging to a patched group can be included in one of three types in connection with reproduction position. These types will now be described systematically.

The first type is that a transmission position on a regular channel and a reproduction position in a client are matched each other. In this case, session of the client is designated as a primary session in its patched group. Since it would be possible that a specified location in a video is simultaneously reproduced by some of clients, one or more primary sessions may exist within one patched group. Data in the primary session(s) do not need to be stored in disk, because the data received through regular channel(s) will be directly reproduced. In FIG. 4, primary session includes sessions of clients that are producing points p0, p3, p6 and p8, respectively.

The second type is that, when patching is completed, while data of a regular channel is stored in a disk of a client and data previously stored in the disk is reproduced. In this case, current reproduction position of a session equals to a value subtracting a patched length value from a transmission position value of the regular channel (the transmission position of the regular channel minus the patched length), and always data as much as the patched length are stored in the disk. In FIG. 4, the second type includes clients that are reproducing points p5, p7 and p9, respectively.

The third type is that, when patching is performing, data on the patched channel is received and reproduced, and at the same time data on the regular channel is stored in the disk.

A reproduction position of a session equals to a value subtracting a patched length value from a transmission position value of the regular channel, and size of data, which is stored in a disk of a client equals to time elapsed since transmission on the patched channel begins. In this case, the size stored in the disk has smaller amount than that of the patched length. In FIG. 4, the third type includes clients that are reproducing points p1, p2, p4, p6 and p8, respectively.

Secondary session represents session that reproduces the nearest portion of video to primary session in a patched group. The secondary session can be converted to a primary session when the current primary session loses its qualification during performing a VCR operation. In FIG. 4, point p1, p4, p7 or p9 can be converted to a secondary session in each patched group.

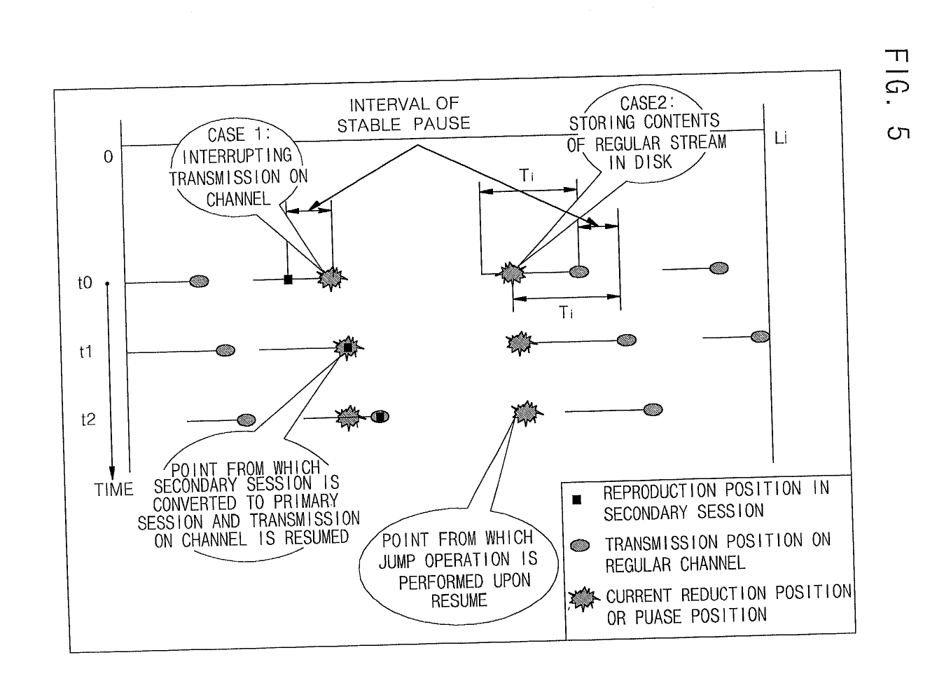

FIG. 5 shows an illustration for explaining concept of a pause/resume method in the video system according to the present invention in connection with the above types. Referring to FIG. 5, the concept will be described on stable pause upon operations of the pause/resume in the video system according to the present invention.

When a user attempts to pause reproduction of a video, a client pauses reproduction on its display and continues to process receiving and storing data of the video in its disk. Therefore, if duration of the pause is small, the data stored in the disk can be rapidly reproduced.

Stable pause enable time indicates the interval that a session resumes a reproduction using data stored in a disk of a client without any change of channel. When duration of pause become larger and an existing regular channel or a patched channel cannot be shared, a jump operation is performed to assign a new regular channel and a new patched channel.

In FIG. 4, Case 1 is that pause occurs for a primary session, and case 2 is that pause occurs for a non-primary session. Duration of stable pause enable time is different for each of the cases.

A client can store data from a video server in a disk of the client during the stable pause enable time. For the case 1, amount of use of channels can be reduced by pausing transmission on regular channels.

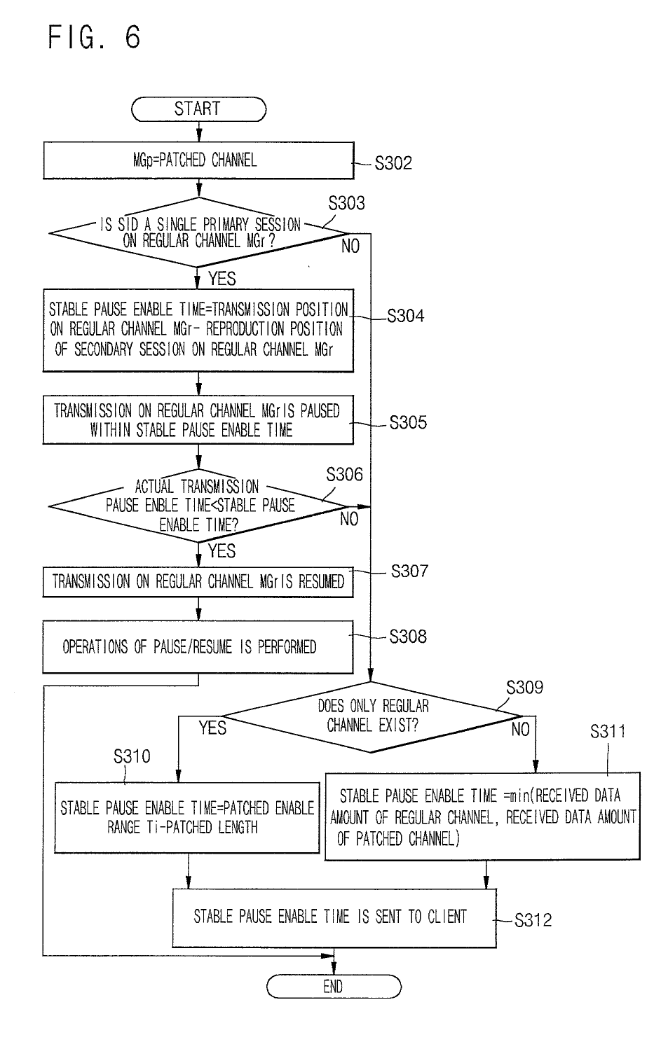

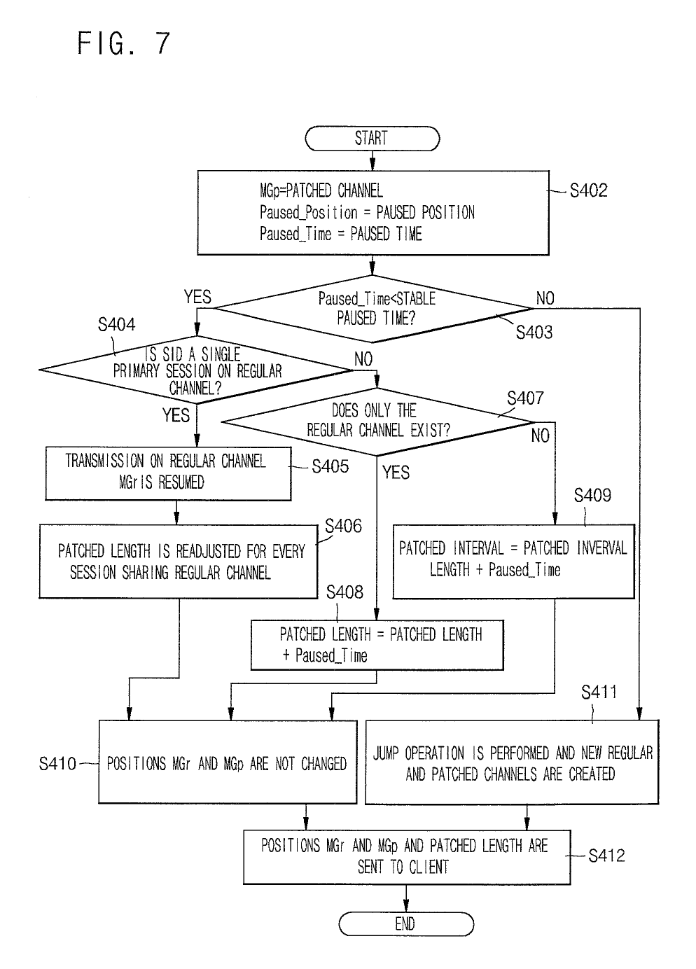

Referring to FIG. 6 and FIG. 7, a pause/resume method in a video system according to the present invention will be described systematically.

At first, the method for pausing reproduction of a video will be described with reference to FIG. 6. FIG. 6 illustrates a flow chart for explaining an operation of pausing reproduction of a video in a video system according to the present invention.

As illustrated in FIG. 6, a session ID, a regular channel and a patched channel are defined as SID, MGr and MGp, respectively, and a client sends its session ID SID and a current reproduction position to a video server to pause reproduction of the video (step S302).

The video server determines if the session ID SID received from the client is a single primary session (step S303). That is, the video server determines if session ID of an associated client is a single primary session in a regular channel.

As a result of the determination, if the session ID of the client is a single primary session in the regular channel, a stable pause enable time can be calculated (step S304). In this case, the stable pause enable time indicates a transmission pause time of the regular channel, and the transmission pause time is a value subtracting reproduction position of a secondary session from transmission position of a regular channel.

In the step S304, when the stable pause enable time has been obtained, if the obtained stable pause enable time falls within a predetermined interval, the video server pauses transmission through the regular channel (step S305). For the pause of transmission through the channel, patched lengths are adjusted for every sessions which share the regular channel.

Then, the video server determines if the transmission pause time falls actually within the obtained stable pause enable time (step S306).

As a result of the determination, if the actual transmission pause time falls actually within the obtained stable pause enable time, that is, if the reproduction is resumed in the obtained stable pause enable time, transmission of the regular channel is resumed (step S307). At this point, there is no need to change the regular channel and the session. If the transmission of the regular channel is resumed in the step S307, operation of pause/resume is performed (step S308).

If, as interval of pause of a session become larger, a primary session loses its qualification and a secondary session obtains its qualification as a new primary session, then multicasting transmission is resumed and the client performs storing data of the regular channel in its disk. Therefore, storage to the disk is performed under existence of the regular channel.

As a result of the determination in the step S303, if session ID SID received from the client is not the single primary session participating in the channel and the actual transmission pause time in the step S206 do not fall within the obtained stable pause enable time, the video server determines if one or both of the client and the regular channel exist(s) (step S309).

As a result of the determination, if only the regular channel exists, the obtained stable pause enable time is calculated (step S310). That is, if only the regular channel exists, the video data as much as patching enable range Ti are received from the regular channel and stored in the disk. The current session has already stored data as much as the patched length in the disk. Therefore, the stable pause enable time, which represents possible additional data under the pause, equals to a value subtracting the patched length of the session from the patching enable range Ti.

On the other hand, if both of the regular channel and the patched channel exist in the step S309, the stable pause enable time is smaller value of size of data received in the regular channel and size of data received in the patched channel. That is, if both of the regular channel and the patched channel exist, the stable pause enable time equals to the received data amount of the regular channel and received data amount of the patched channel.

As stated above, the stable pause enable times in the case that only the regular channel exists as in the step S310 and the case that both of the regular channel and the patched channel exist as in the step S311, are sent to the client (step S312).

Method for resuming will be described with reference to FIG. 7.

FIG. 7 illustrates a flow chart for explaining an operation of resume and reproduction of a video in the video system according to the present invention.

At first, a session ID, a regular channel, a patched channel, a paused position and a paused time are defined as SID, MGr, MGp, Paused_Position and Paused_Time, respectively (step S401). If a client sends the session ID SID, the pause position Paused_Position and the pause time Paused_Time to the video server (step S401), the client receives information for the regular channel, the patched channel, the patched length and the waiting time from the video server.

If the client sends the session ID SID, the pause position Paused_Position and the pause time Paused_Time to the video server, the video server determines if the paused time of the client falls within a predetermined stable pause time (step S403).

As a result of the determination, when the pause time of the client falls within a predetermined stable pause time, that is, when reproduction is resumed within duration of the stable pause, there is no change of the channel. In this case, since a new channel is not created, waiting time is not required.

Then, the video server determines if the session ID SID of the client is a single primary session (step S404). As a result of the determination, when the session ID SID is a single primary session, transmission on the regular channel is resumed (step S405).

When the transmission of the regular channel is resumed, the current session still remains as the primary session of the regular channel. The enforcement of transmission resume of the regular channel permits to perform re-adjustment of the patched length for every session sharing the regular channel (step S406).

However, if session ID SID of the client is not the single primary session of the regular channel in the step S404, the video server determines if only the regular channel exists (step S407).

If only the regular channel exists, the pause enable time Paused_Time is added to the patched length (step S408), and if both of the regular channel and the patched channel exist, the pause enable time Paused_Time is added to the patched length (step S409).

A patched channel process thread of a client performs storing data into a disk of the client during patching process, because a patched channel performs transmitting in a position adding Paused_Time to reproduction position of a current client.

After the processes of the steps S406, s408 and S409, without any change of the regular channel and the patched channel (step S410), the regular channel, the patched channel and the patched length value obtained in the steps S408 and S409 are delivered to the associated client (step S412).

However, if the pause enable time Paused_Time of the client exceeds the stable pause enable time in the step S403, a jump operation is performed for the pause enable position Paused_Position (step S411). That is, if the pause enable time Paused_Time of the client exceeds the stable pause enable time, a new regular channel and a new patched channel are created, and the regular channel, the patched channel and the patched length, which are created, are delivered to the associated client.

In other words, if the pause enable time of the client exceeds the stable pause enable time, a jump operation is performed for the pause enable position Paused_Position, and the regular channel, the patched channel, the patched length and the waiting time, which are created by the jump operation, are delivered to the associated client.

As a result, the problem of a pause/resume method of patching based VOD system in a prior art, which a prescribed time interval is fixed and the service requested during the interval is processed, is solved by changing the channel group of transferred stream. When an operation of pause is performed, transmission of video data is temporarily paused, and when an operation of resume is performed, the nearest transferring channel group is found. However, although VOD system, which transfers simultaneously data via at most 2 channels, operations of pause/resume can not be provided, pause/resume method and its apparatus in the video system according to the present invention can provide the operations of the pause/resume of the VOD in multicasting environment, which data are simultaneously transferred via 2 channels.

As described above, the pause/resume method and its apparatus in the video system according to the present invention can provide the operations of the pause/resume of the VOD in multicasting environment, using minimum channels. The present invention allows a user to interact for video data, thus increases utility of the system.

The embodiment described above is illustrative example of the present invention and it should not be construed that the present invention is limited to these particular embodiment. Various changes and modifications may be effected by the skilled in the art without departing from the spirit or scope of the invention as defined in the appended claims.

What is claimed is:

1. A pause method in a video system using a regular channel and a patched channel, comprising:
determining if current session of an associated client is a single primary session in the regular channel, when receiving ID of the session and a reproduction position of a video from the client;
in response to result of the determination, examining a stable pause enable time, if the session is the single primary session in the regular channel;
in response to result of the examination, after pausing transmission of the video data to the client via the regular channel, obtaining an actual video transmission pause time and comparing it with the obtained stable pause enable time; and
in response to result of the comparison, transferring the video data to the client via the regular channel, after releasing the pause, if the obtained stable pause enable time is longer than the actual transmission pause time.

2. A method as defined in claim 1 in which the transmission pause of the video information performs pausing as duration as the obtained stable pause enable time.

3. A method as defined in claim 1 in which the stable pause enable time is the time which reproduction position of secondary session of the regular channel is subtracted from the transmission position of the regular channel.

4. A method as defined in claim 1, the method comprising the further steps of:
determining if only the current regular channel exists in the associated client, when the current session is not the single primary session of the regular channel and when the actual transmission pause time is less than the stable pause enable time; and
in response to result of the determination, receiving and storing only video informations as much as the current video information patching enable range from the regular channel, when only the current regular channel exists in the associated client.

5. A method as defined in claim 4 in which, in the receiving and storing only video informations as much as the current video information patching enable range from the regular channel, video data as much as the patched length is stored in advance in the current session of the associated client, and the stable pause enable time, which represents additional storage enable video data in a pause enable state equals to the time that the patched length of the current session is subtracted from the patching enable range.

6. A method as defined in claim 4 in which when both of the regular channel and the patched channel exist in the step of determining if only the regular channel exists, the method further comprising:
receiving video data as much as the patched length via the patched channel, and video data as much as the stable pause enable time via the regular channel.

7. A method as defined in claim 6 in which the stable pause enable time is the time that the patched length is subtracted from the patching enable range.

8. A method as defined in claim 6 or 7 in which the stable pause enable time is less one of size of the data received from the regular channel or size of the data received from the patched channel.

9. A video data transfer resume method in a video system, comprising:
determining, when a video reproduction is temporarily paused, if a video reproduction signal is received, after receiving informations including session ID, paused position and paused time;
comparing the paused position with a predetermined stable pause enable time, when the video reproduction signal can be received within the predetermined stable pause enable time;
in response to result of the comparison, determining if it is a single primary session in which associated client shares the regular channel, when the paused time falls within the stable pause enable time;
in response to result of the determination, resuming transfer in the regular channel and adjusting patched lengths of sessions sharing the regular channel, when it is the single primary session; and
transferring the patched length, the regular channel and patched channel value, which are adjusted, as pause enable resume value to the client.

10. A method as defined in claim 9 in which when it is not a single primary session in which the associated client shares the regular channel, the method further comprising:
determining if only the regular channel exists in the associated client; and
adding the pause enable time of the video reproduction to the patched length, when both of the regular channel and the patched channel exist.

11. A method as defined in claim 10 in which in the patched channel, position information, which the pause enable time is added to the current reproduction position of the current client, is transferred and the video data can be stored in the disk during process of patching.

12. A method as defined in claim 9 in which when the pause enable time not fall within the stable pause enable time, the method further comprising:
performing jump operation for the pause enable position and creating a new regular channel and a new patched channel; and
transferring information of waiting time to the client as video reproduction operation value via the new regular channel and the new patched channel.

13. A program storage device readable by a machine, tangibly embodying a program of instructions executable by the machine to perform method steps for providing for pause/resume of video reproduction in video system using a regular channel and a patched channel, the method steps comprising:
determining if current session of an associated client is a single primary session in the regular channel, when receiving ID of the session and a reproduction position of a video from the client;
in response to result of the determination, examining a stable pause enable time, if the session is the single primary session in the regular channel;
in response to result of the examination, after pausing transmission of the video data to the client via the regular channel, obtaining an actual video transmission pause time and comparing it with the obtained stable pause enable time; and
in response to result of the comparison, transferring the video data to the client via the regular channel, after releasing the pause, if the obtained stable pause enable time is longer than the actual transmission pause time.

14. A program storage device readable by a machine, tangibly embodying a program of instructions executable by the machine to perform method steps for providing for pause/resume of video reproduction in video system using a regular channel and a patched channel, the method steps comprising:
determining, when a video reproduction is temporarily paused, if a video reproduction signal is received, after receiving informations including session ID, paused position and paused time;
comparing the paused position with a predetermined stable pause enable time, when the video reproduction signal can be received within the predetermined stable pause enable time;
in response to result of the comparison, determining if it is a single primary session in which associated client shares the regular channel, when the paused time falls within the stable pause enable time;
in response to result of the determination, resuming transfer in the regular channel and adjusting patched lengths of sessions sharing the regular channel, when it is the single primary session; and
transferring the patched length, the regular channel and patched channel value, which are adjusted, as pause enable resume value to the client.
